(19) United States
(12) Patent Application Publication
(10) Pub. No.: US 2009/0247264 A1
(43) Pub. Date: Oct. 1, 2009

(54) GAMING MACHINE AND PLAYING METHOD THEREOF

(75) Inventor: Yukinori Inamura, Koto-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 12/207,829

(22) Filed: Sep. 10, 2008

Related U.S. Application Data
(60) Provisional application No. 61/040,028, filed on Mar. 27, 2008.

(51) Int. Cl. A63F 9/24; A63F 13/00

(52) U.S. Cl. 463/20

(57) ABSTRACT

A gaming machine executes a slot game using all of a plurality of kinds of planet symbols and card symbols as scatter symbols, and displays rearranged symbols in partitioned regions on a display. When the rearranged symbols include a predetermined number or more of the planet symbols of the same kind, a payout is generated in the slot game. Moreover, when the rearranged symbols form a special combination in which the planet symbols of different kinds from each other are arranged in a cross or linear pattern, a jackpot bonus payout is generated.

### CROSS REFERENCE TO RELATED APPLICATIONS

This application claims priority to co-pending U.S. provisional patent application Ser. No. 61/040,028 filed on Mar. 27, 2008, and which is incorporated by reference herein for all purposes.

### BACKGROUND OF THE INVENTION

1. Field of the Invention

The present invention relates to a gaming machine and a playing method thereof.

2. Description of the Related Art

As described in U.S. Pat. No. 5,820,459 specification, U.S. Pat. No. 6,695,697 specification, U.S. Patent Application Publication No. 2003/0,069,073 specification, European Patent Application Publication No. 1,192,975 specification, U.S. Pat. No. 6,254,483 specification, U.S. Pat. No. 6,611,730 specification, U.S. Pat. No. 5,639,088 specification, U.S. Pat. No. 6,257,981 specification, U.S. Pat. No. 6,234,896 specification, U.S. Pat. No. 6,001,016 specification, U.S. Pat. No. 6,273,820 specification, U.S. Pat. No. 6,224,482 specification, U.S. Pat. No. 4,669,731 specification, U.S. Pat. No. 6,244,957 specification, U.S. Pat. No. 5,910,048 specification, U.S. Pat. No. 5,695,402 specification, U.S. Pat. No. 6,003,013 specification, U.S. Pat. No. 4,283,709 specification, European Patent Application Publication No. 0,631,798 specification, German Patent Application Publication No. 4,137,010 specification, British Patent Application Publication No. 2,326,830 specification, German Patent Application Publication No. 3,712,841 specification, U.S. Pat. No. 4,964,638 specification, U.S. Pat. No. 6,089,980 specification, U.S. Pat. No. 5,280,909 specification, U.S. Pat. No. 5,702,303 specification, U.S. Pat. No. 6,270,409 specification, U.S. Pat. No. 5,770,533 specification, U.S. Pat. No. 5,836,817 specification, U.S. Pat. No. 6,932,704 specification, U.S. Pat. No. 6,932,707 specification, U.S. Pat. No. 4,837,728 specification, European Patent Application Publication No. 1,302,914 specification, U.S. Pat. No. 4,624,459 specification, U.S. Pat. No. 5,564,700 specification, PCT Patent Application Publication No. 03/083,795 specification, German Patent Application Publication No. 3,242,890 specification, European Patent Application Publication No. 0,840,264 specification, German Patent Application Publication No. 10,049,444 specification, PCT Patent Application Publication No. 04/095,383 specification, European Patent Application Publication No. 1,544,811 specification, U.S. Pat. No. 5,890,963 specification, European Patent Application Publication No. 1,477,947 specification, and European Patent Application Publication No. 1,351,180 specification, in a facility in which gaming machines such as slot machines are provided, a player can play a game provided by a gaming machine by making bets such as coins, credits, etc., at that gaming machine.

For example, every time a player makes a bet in a slot machine and presses a start switch, the slot machine executes a slot game in which a plurality of symbols arranged on a display are rearranged. Thereafter, when the symbols thus rearranged on the display include a predetermined number of scatter symbols or a predetermined winning combination is formed on a payline, the slot machine provides a payout corresponding to contents of the scatter symbols or the winning combination. Among the slot machines, there is also a slot machine which executes an all-scatter slot game using all the symbols as scatter symbols.

Furthermore, the slot machine also provides a payout called a jackpot. Specifically, the slot machine accumulates some of wagers placed in the slot machine for a jackpot payout. The jackpot payout can be provided, for example, when specific symbols are rearranged on the display.

In this case, in the slot machine which executes the all-scatter slot game, it is required to regard any one of a plurality of the scatter symbols as a jackpot trigger symbol. Moreover, in the slot machine which provides a payout when a winning combination is formed on the payline, it is conceivable to newly add the jackpot trigger symbol.

In either case, the player is required to memorize the jackpot trigger symbol beforehand. If characters notifying the player of the jackpot trigger symbol are displayed to be overlapped with the symbol, the player is no longer required to memorize the jackpot trigger symbol beforehand. On the other hand, decorative freedom of the symbols is lowered.

### SUMMARY OF THE INVENTION

It is an object of the present invention to provide a gaming machine with improved entertainment properties, in which rearrangement of a specific symbol on a display is not regarded as a trigger for bonus payout, and a playing method thereof.

A first aspect of the present invention is a gaming machine comprising: a display configured to display a unit game to arrange and rearrange a plurality of scatter symbols for awards; and a controller configured to (a) select in the unit game the scatter symbols to be rearranged from among a plurality of kinds of scatter symbols including a plurality of kinds of specific scatter symbols and at least one kind of base scatter symbol, and (b) provide an award for a special bonus upon a plurality of the scatter symbols rearranged in the unit game forming a special combination in which a plurality of the specific scatter symbols of different kinds from each other are arranged in a predetermined pattern.

A second aspect of the present invention is a gaming machine comprising: a display configured to display a unit game to rearrange a plurality of arranged symbols; and a controller configured to (a) select in the unit game the symbols to be rearranged from among a plurality of kinds of symbols including a plurality of kinds of specific symbols and at least one kind of base symbol, and (b) provide an award for a special bonus upon a plurality of the symbols rearranged in the unit game forming a special combination in which a plurality of the specific symbols of different kinds from each other are arranged in line, on a payline set on the display.

A third aspect of the present invention is a gaming machine comprising: a display configured to display a unit game to rearrange a plurality of arranged symbols; a button configured to specify, for each unit game, a payline for bet among a plurality of paylines set on the display; and a controller configured to (a) select in the unit game the symbols to be rearranged from among a plurality of kinds of symbols including a plurality of kinds of specific symbols and at least one kind of base symbol, and (b) provide an award for a special bonus upon a plurality of the symbols rearranged in the unit game forming a special combination in which a plurality of the specific symbols of different kinds from each other are arranged in line, on the payline specified for bet in response to an operation of the button by the player.

A fourth aspect of the present invention is a method for playing a gaming machine configured to display on a display a unit game to arrange and rearrange a plurality of scatter symbols for awards, the method comprising: selecting in the unit game the scatter symbols to be rearranged from among a plurality of kinds of scatter symbols including a plurality of kinds of specific scatter symbols and at least one kind of base scatter symbol; and providing an award for a special bonus upon a plurality of the scatter symbols rearranged in the unit game forming a special combination in which a plurality of the specific scatter symbols of different kinds from each other are arranged in a predetermined pattern.

A fifth aspect of the present invention is a method for playing a gaming machine configured to display on a display a unit game to rearrange a plurality of arranged symbols, the method comprising: selecting in the unit game the symbols to be rearranged from among a plurality of kinds of symbols including a plurality of kinds of specific symbols and at least one kind of base symbol, and providing an award for a special bonus upon a plurality of the symbols rearranged in the unit game forming a special combination in which a plurality of the specific symbols of different kinds from each other are arranged in line, on a payline set on the display.

A sixth aspect of the present invention is a method for playing a gaming machine configured to specify a payline for bet among a plurality of paylines set on a display configured to display a unit game to rearrange a plurality of arranged symbols, for each unit game in response to an operation of a button by a player, the method comprising: selecting in the unit game the symbols to be rearranged from among a plurality of kinds of symbols including a plurality of kinds of specific symbols and at least one kind of base symbol; and providing an award for a special bonus upon a plurality of the symbols rearranged in the unit game forming a special combination in which a plurality of the specific symbols of different kinds from each other are arranged in line, on the payline specified for bet in response to the operation of the button by the player.

### BRIEF DESCRIPTION OF THE DRAWINGS

FIG. 1A is an explanatory view showing a display example displayed on a display on a slot machine according to a first embodiment of the present invention.

FIG. 1B is an explanatory view showing a display example displayed on the display on the slot machine according to the first embodiment of the present invention.

FIG. 2 is an explanatory view showing partitioned regions in a matrix pattern provided on the display on the slot machine according to the first embodiment of the present invention.

FIG. 3 is a perspective view of the slot machine according to the first embodiment of the present invention.

FIG. 4 is a block diagram showing a control circuit in the slot machine according to the first embodiment of the present invention.

FIG. 5 is a schematic diagram showing a payout table used in the slot machine according to the first embodiment of the present invention.

FIG. 6 is a flowchart showing procedures of processing executed by the slot machine according to the first embodiment of the present invention.

FIG. 7 is a flowchart showing procedures of processing executed by the slot machine according to the first embodiment of the present invention.

FIG. 8 is a flowchart showing procedures of processing executed by the slot machine according to the first embodiment of the present invention.

FIG. 9 is a flowchart showing procedures of processing executed by the slot machine according to the first embodiment of the present invention.

FIG. 10 is a schematic diagram showing a payout table used in a slot machine according to a second embodiment of the present invention.

FIG. 11 is a perspective view of a slot machine according to a third embodiment of the present invention.

FIG. 12 is an explanatory view showing paylines that can be set in partitioned regions in a matrix pattern provided on a display on the slot machine according to the third embodiment of the present invention.

FIG. 13 is an explanatory view showing paylines that can be set in the partitioned regions in the matrix pattern provided on the display on the slot machine according to the third embodiment of the present invention.

FIG. 14 is an explanatory view showing paylines that can be set in the partitioned regions in the matrix pattern provided on the display on the slot machine according to the third embodiment of the present invention.

FIG. 15 is an explanatory view showing paylines that can be set in the partitioned regions in the matrix pattern provided on the display on the slot machine according to the third embodiment of the present invention.

FIG. 16 is a perspective view of a slot machine according to a fourth embodiment of the present invention.

FIG. 17 is a block diagram showing a control circuit in the slot machine according to the fourth embodiment of the present invention.

FIG. 18A is a perspective view showing a rotating reel device in the slot machine according to the fourth embodiment of the present invention.

FIG. 18B is a side view showing the rotating reel device in the slot machine according to the fourth embodiment of the present invention.

### DETAILED DESCRIPTION OF THE EMBODIMENT

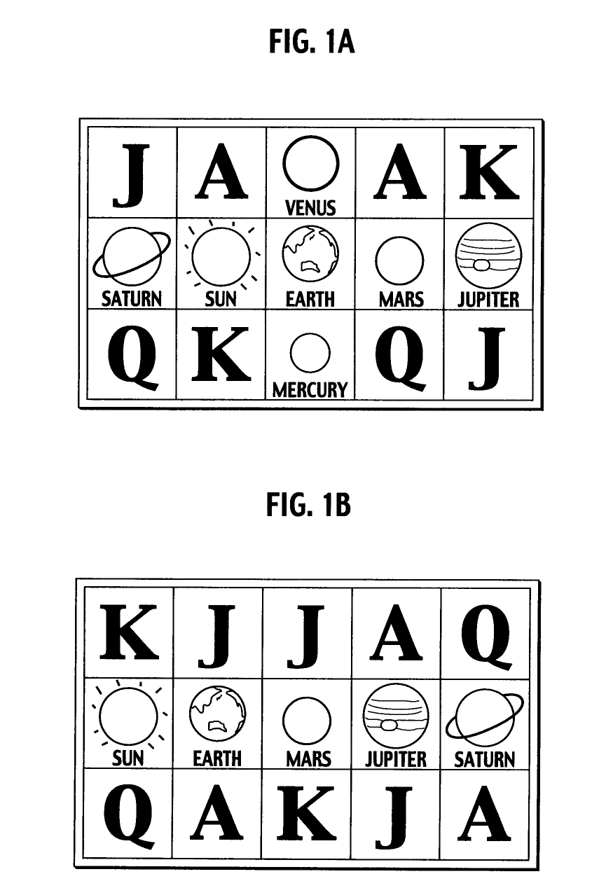

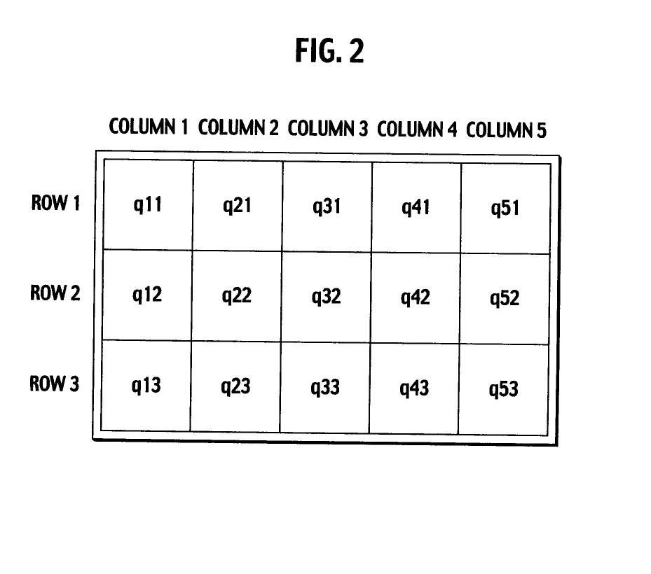

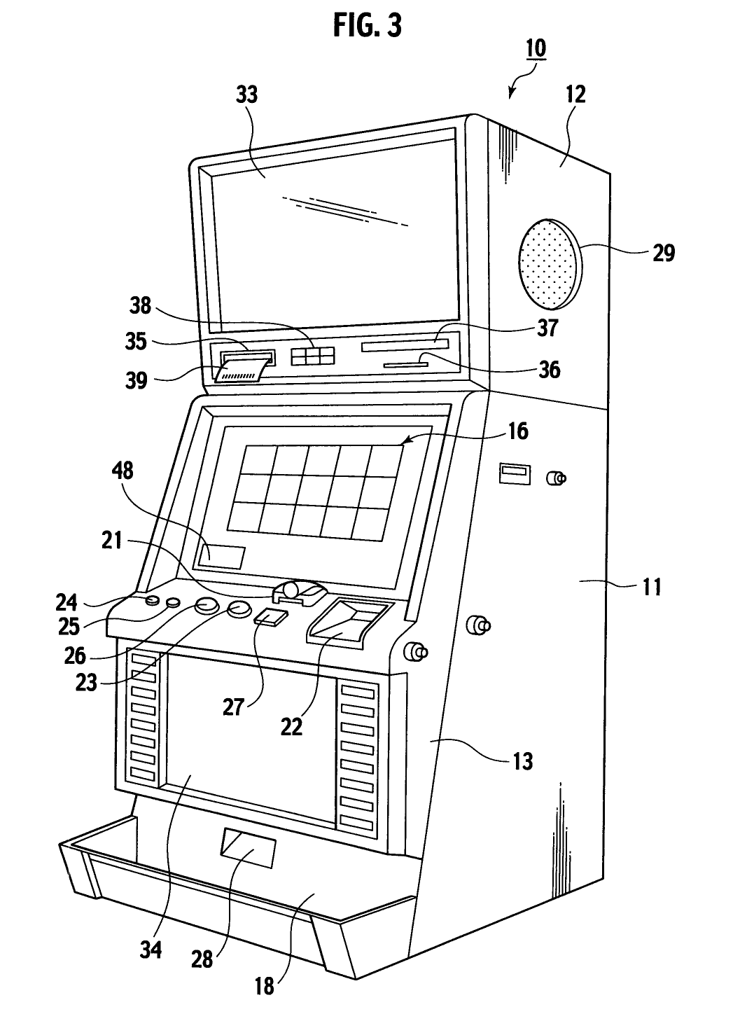

With reference to FIGS. 1A, 1B, 2 and 3, outline will be given below of operations and a playing method of a slot machine according to an embodiment of the present invention, which is an example of a gaming machine according to the present invention. FIGS. 1A and 1B are explanatory views showing display examples displayed on a display on the slot machine according to this embodiment. FIG. 2 is an explanatory view showing partitioned regions in a matrix pattern provided on the display on the slot machine according to this embodiment. FIG. 3 is a perspective view of the slot machine according to this embodiment.

A display 16 shown in FIG. 1A (a display) is provided on a front surface of a cabinet 11 of a slot machine 10 shown in FIG. 3. The display 16 has fifteen partitioned regions q11 to q53 as shown in FIG. 2. These partitioned regions q11 to q53 are arranged in a matrix pattern composed of first to fifth columns and first to third rows.

In the slot machine 10 shown in FIG. 3 according to this embodiment, every time a unit game is played, symbols arranged in the partitioned regions q11 to q53 shown in FIG. 2 described above are rearranged. The symbol to be rearranged in each of the partitioned regions q11 to q53 is any one of eleven kinds of symbols shown in FIGS. 1A and 1B, including, for example, seven kinds of planet symbols (specific scatter symbols) such as “VENUS”, “MERCURY”, “SATURN”, “SUN”, “EARTH”, “MARS” and “JUPITER”, and four kinds of card symbols (base scatter symbols) such as “A (ace)”, “K (king)”, “Q (queen)” and “J (jack)”.

When the symbols are rearranged in the partitioned regions q11 to q53, respectively, in the unit game, the number of credits to be provided as a payout is determined according to rules of a predetermined payout table. Thereafter, a payout (an award) for the determined number of credits is provided. Subsequently, the symbols in the respective partitioned regions q11 to q53 are rearranged as the next unit game is started.

In the case where the slot machine 10 shown in FIG. 3 is one that executes an all-scatter type unit game using all the symbols as scatter symbols, when a predetermined number or more of symbols of the same kind are rearranged in the partitioned regions q11 to q53, a payout (an award) for the number of credits corresponding to the kinds of the symbols and the number of the symbols rearranged is generated as a payout (an award) for the unit game.

Moreover, in the case where the slot machine 10 shown in FIG. 3 is one that executes a winning combination type unit game, when a winning combination is formed on a payline set in the partitioned regions q11 to q53, a payout for the number of credits corresponding to contents of the winning combination formed is generated as a payout for the unit game.

Furthermore, in the case where the slot machine 10 shown in FIG. 3 is the one that executes the all-scatter type unit game, when the symbols rearranged in the partitioned regions q11 to q53 form a special combination, a special bonus payout accumulated for a jackpot is generated. Specifically, in the special combination, a plurality of the planet symbols different from each other are arranged in a predetermined pattern.

The special combination described above may be, for example, a combination including the planet symbols “VENUS”, “MERCURY”, “SATURN”, “SUN”, “EARTH”, “MARS” and “JUPITER” arranged in a cross pattern as shown in FIG. 1A.

Moreover, the special combination may also be, for example, a combination in which five out of seven kinds of the planet symbols are arranged in a pattern on a straight line across the first to fifth columns as shown in FIG. 1B.

In the slot machine and its playing method according to the embodiment of the present invention as described above, in both cases of executing the all-scatter type unit game and the winning combination type unit game, whether or not to generate the special bonus payout is determined by a rearrangement pattern of the planet symbols involved in determination of the payout for the unit game.

Therefore, the special bonus payout can be generated based on the result of the symbol rearrangement in the unit game without newly adding symbols other than the symbols involved in determination of the payout for the unit game. Thus, it is possible to eliminate the need for the player to memorize beforehand the kinds (contents) of the symbols to serve as a special bonus trigger. Alternatively, in order to eliminate the need described above, it is possible to avoid overlapping with the symbols when displaying characters, marks and the like, which indicate the symbols to serve as the special bonus trigger in an easy-to-understand manner for the player.

Thus, entertainment properties of the gaming machine and a playing method thereof can be improved without impairing decorative freedom of the symbols.

Next, detailed description will be given of the slot machine according to the first embodiment of the present invention. As shown in FIG. 3, the slot machine 10 according to this embodiment includes the cabinet 11, a top box 12 provided on the cabinet 11 and a main door 13 provided on the front surface of the cabinet 11. On a front side of the main door 13, the display 16 is provided. As shown in FIG. 2, the display 16 has fifteen partitioned regions q11 to q53 arranged in a matrix pattern including first to fifth columns and first to third rows. Moreover, the display 16 includes a liquid crystal panel, which displays symbols rearranged in the partitioned regions q11 to q13 and q51 to q53 on the display 16.

Note that, in this embodiment, medals are taken as an example of game media to be used for executing games. However, the game media are not limited to the medals but may include, for example, medals, tokens, electronic money and valuable electronic information (credits) equivalent thereto.

Below the display 16, provided are: various operation switches used by the player to input instructions related to a game process; a medal insertion slot 21 for accepting coins; and a bill validator 22 for validating whether or not bills are legitimate and for accepting the legitimate bills. Note that the bill validator 22 may be configured to be able to read a bar-coded ticket 39.

Moreover, in the vicinity of the medal insertion slot 21 and the bill validator 22, various operation switches are provided. As the operation switches, a payout switch 23, a MAXBET switch 24, a BET switch 25, a spin repeat bet switch 26 and a start switch 27 are provided.

The BET switch 25 is a switch for determining the number of credits to be bet on a slot game (unit game) to be executed on the display 16. As described later, every time the BET switch 25 is pressed, a credit for 1 medal is bet.

The spin repeat bet switch 26 is a switch for executing the slot game by betting credits again without changing the number of credits bet by use of the BET switch 25 described above in the previous game.

The start switch 27 is a switch for starting the slot game after a desired number of credits are bet. When the start switch 27 is pressed after medals are inserted into the medal insertion slot 21 or credits are bet by use of the BET switch 25, the slot game is started on the display 16.

The payout switch 23 is a switch for providing a payout of inserted medals. The medals to be provided are discharged from a medal payout opening 28 provided open in a lower front portion of the main door 13. The medals provided are accumulated in a medal tray 18.

The MAXBET switch 24 is a switch for betting, in one operation, the maximum number of credits (for example, 30 medals) that can be bet on one game.

On a lower front surface of the main door 13, a foot display 34 is provided, which displays predetermined images based on image display control data included in game software that is being executed. These images include, for example, characters of the slot machine 10, and the like.

On a front surface of the top box 12, an upper display 33 is provided. The upper display 33 includes a liquid crystal panel to display a payout table and the like.

Moreover, a speaker 29 is provided in the top box 12. Below the upper display 33, a ticket printer 35, a card reader 36, a data display 37 and a keypad 38 are provided. The ticket printer 35 prints out a bar-code on a ticket, the bar-code having coded data such as the number of credits, time, date and an identification number of the slot machine 10, and outputs the ticket as the bar-coded ticket 39.

The player can use the bar-coded ticket 39 to play a game with another slot machine by allowing the slot machine to read the bar-coded ticket or can exchange the bar-coded ticket 39 with bills and the like at a predetermined location in a gaming facility (for example, a cashier in a casino).

The card reader 36 allows a smart card to be inserted thereinto, reads data from the inserted smart card and writes data into the smart card. The smart card is a card carried by the player and stores data for identifying the player and data on a gaming record played by the player.

The smart card may store data corresponding to coins, bills or credits. Moreover, instead of the smart card, a magnetic stripe card may be adopted. The data display 37 is composed of a fluorescent display or the like and displays, for example, the data read by the card reader 36 and data inputted by the player using the keypad 38.

Moreover, instead of the smart card, an RFID card capable of reading and writing data contactlessly may be used. The keypad 38 is for inputting instructions or data for ticketing and the like.

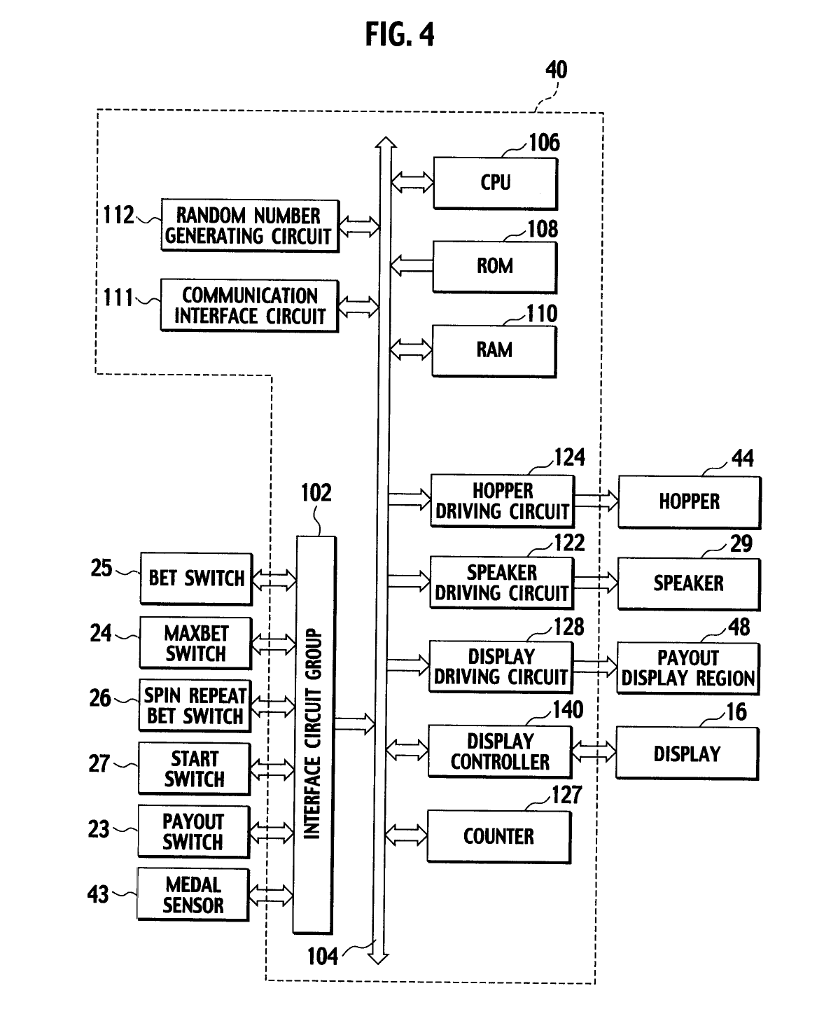

FIG. 4 is a block diagram showing a control circuit in the slot machine according to this embodiment. A controller 40 shown in FIG. 4 is a microcomputer, including an interface circuit group 102, an I/O bus 104, a CPU 106, a ROM 108, a RAM 110, a communication interface circuit 111, a random number generating circuit 112, a speaker driving circuit 122, a hopper driving circuit 124, a display driving circuit 128 and a display controller 140.

The interface circuit group 102 is connected to the I/O bus 104. The I/O bus 104 inputs and outputs a data signal or an address signal to and from the CPU 106.

The start switch 27 is connected to the interface circuit group 102. A start signal outputted from the start switch 27 is converted into a predetermined signal by the interface circuit group 102 and then transmitted to the CPU 106 through the I/O bus 104.

The BET switch 25, the MAXBET switch 24, the spin repeat bet switch 26 and the payout switch 23 are further connected to the interface circuit group 102. Each of switching signals outputted from the switches 25, 24, 26 and 23 is supplied to the interface circuit group 102, converted into a predetermined signal by the interface circuit group 102 and then transmitted to the CPU 106 through the I/O bus 104.

In addition, a medal sensor 43 is connected to the interface circuit group 102. The medal sensor 43 is a sensor for detecting medals inserted into the medal insertion slot 21 and is provided in a medal insertion part of the medal insertion slot 21. A detection signal outputted by the medal sensor 43 is supplied to the interface circuit group 102, converted into a predetermined signal by the interface circuit group 102 and then transmitted to the CPU 106 through the I/O bus 104.

The ROM 108 storing system programs and the RAM 110 for storing various data are connected to the I/O bus 104. In the RAM 110, there are provided areas and the like for managing flags and storing various information.

The ROM 108 stores a payout table. The payout table shows a correspondence relationship between conditions for generating a payout (an award) and the number of credits to be provided as a payout (an award) when the conditions are satisfied. In this embodiment, the conditions for generating a payout are represented by the symbols stopped in any one of the partitioned regions q11 to q53 on the display 16, in other words, stop-symbols and the number of the stop-symbols. In the slot game of this embodiment, the CPU 106 determines whether or not to generate a payout (whether or not to provide a payout of credits) and the credit payout number (the number of credits to be provided as a payout) depending on the payout table and the symbols stopped in the partitioned regions q11 to q53, respectively.

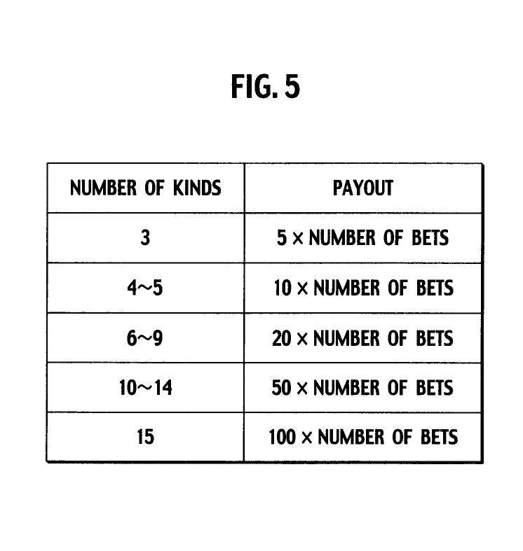

FIG. 5 is an explanatory view showing a payout table associated with a slot game, the payout table being stored in the ROM 108. In this embodiment, the payout table common to the eleven kinds of symbols is set. In this payout table, as shown in FIG. 5, when the number of symbols of the same kind (the number of KINDs), symbols being rearranged in the partitioned regions q11 to q53, is “3”, a payout is set to 5× the number of credits bet. When the number of symbols of the same kind is “4 or 5”, a payout is set to 10× the number of credits bet. When the number of symbols of the same kind is “6 to 9”, a payout is set to 20× the number of credits bet. When the number of symbols of the same kind is “10 to 14”, a payout is set to 50× the number of credits bet. When the number of symbols of the same kind is “15”, a payout is set to 100× the number of credits bet.

As described above, in the slot machine 10 according to this embodiment, the payout is not generated when a winning combination is formed on a payline set on the display 16 but is determined according to the kinds of the symbols stopped in the partitioned regions q11 to q53 and the number thereof.

Upon receipt of a game start operation with the start switch 27, the CPU 106 executes a game by reading a game execution program from the ROM 108. The game execution program is a program for executing a slot game on the display 16 through the display controller 140.

To be more specific, as the program for executing the slot game, the game execution program is configured to execute the following slot game. Specifically, symbol varying and displaying is performed simultaneously in the partitioned regions q11 to q53 on the display 16 and then the symbols are stopped. When the symbols are rearranged so as to form a pattern to generate a payout, credits are provided as a payout of the payout number based on the payout table stored in the ROM 108.

The random number generating circuit 112, the communication interface circuit 111, the display controller 140, the hopper driving circuit 124, the speaker driving circuit 122, a counter 127 and the display driving circuit 128 are further connected to the I/O bus 104.

The communication interface circuit 111 is connected to a hall server and the like and transmits to the hall server data on a record of plays executed in the slot machine 10. Moreover, the communication interface circuit 111 receives various data transmitted from the hall server.

The random number generating circuit 112 generates a random number for determining whether or not to generate a winning combination or a jackpot in the slot game executed on the display 16.

The counter 127 has a function of counting jackpot bonus resources. When a wager is placed on one slot game with contents that satisfy predetermined conditions, the jackpot bonus resources counted by the counter 127 are accumulated according to some (amount) of the wager. Note that the counter 127 can also be set inside the RAM 110.

The display driving circuit 128 performs control of displaying the number of payouts in a payout number partitioned region 48 set in the lower left area of the display 16.

The speaker driving circuit 122 outputs sound data to the speaker 29. Specifically, the CPU 106 reads sound data stored in the ROM 108 and transmits the sound data to the speaker driving circuit 122 through the I/O bus 104. Thus, predetermined sound effects are emitted from the speaker 29.

The hopper driving circuit 124 outputs a payout signal to the hopper 44 when a payout is generated. Specifically, when a payout signal is inputted by the payout switch 23, the CPU 106 outputs a driving signal to the hopper driving circuit 124 through the I/O bus 104. Thus, the hopper 44 provides a payout of medals equivalent to the number of credits remaining at the time, which is stored in a predetermined memory region of the RAM 110.

The display controller 140 performs display control for executing an effect corresponding to a slot game and an outcome of the slot game on the display 16. Specifically, the CPU 106 generates an image display command signal corresponding to a state of the slot game and the outcome of the slot game and outputs the image display command signal to the display controller 140 through the I/O bus 104. Upon receipt of the image display command signal outputted by the CPU 106, the display controller 140 generates a driving signal for driving the display 16 based on the image display command and outputs the generated driving signal to the display 16. Thus, an effect screen corresponding to the slot game and the outcome thereof is displayed on the display 16.

The CPU 106 outputs, to the display controller 140, an image display command for displaying an image of the slot game and an effect image corresponding to the outcome of the slot game on the display 16 at a timing corresponding to a course of the slot game. Accordingly, an effect corresponding to the slot game and the outcome thereof is displayed on the display 16.

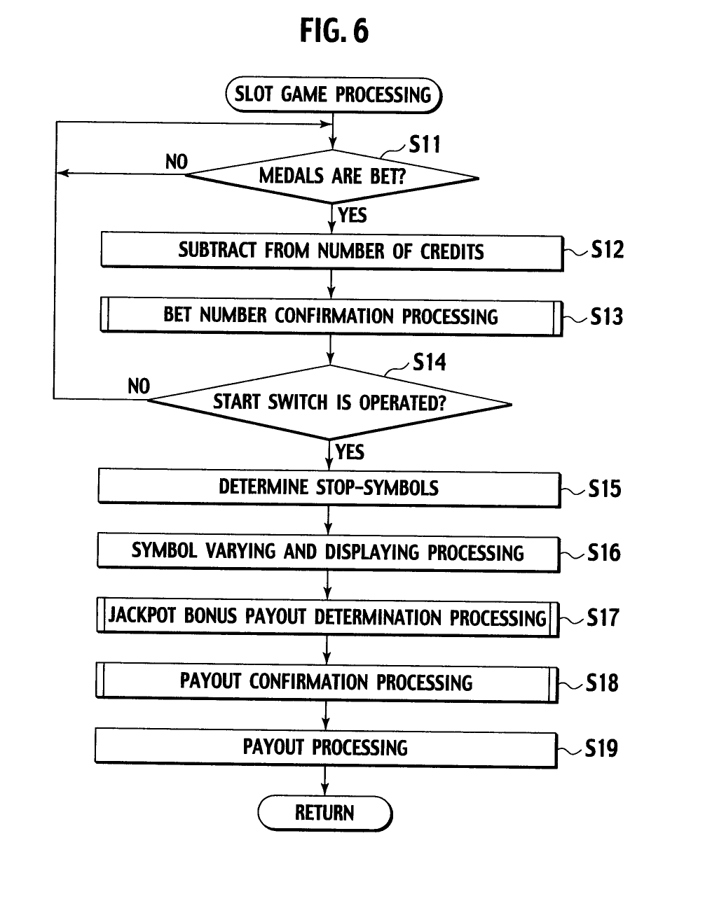

Next, with reference to a flowchart shown in FIG. 6, operations of the slot machine according to this embodiment will be described. FIG. 6 is the flowchart showing procedures of slot game processing executed by the CPU 106 shown in FIG. 4 according to the game execution program stored in the ROM 108.

In the slot game processing shown in FIG. 6, first, the CPU 106 determines whether or not credits are bet in Step S11. In this step, the CPU 106 determines whether or not any one of a signal outputted from the BET switch 25 when the BET switch 25 is pressed or a signal outputted from the MAXBET switch 24 when the MAXBET switch 24 is pressed is received. When the CPU 106 determines that no credits are bet, the processing returns to Step S11.

Meanwhile, when it is determined in Step S11 that the credits are bet, the CPU 106 moves to Step S12 and reduces the number of credits stored in the RAM 110 according to the number of the credits bet.

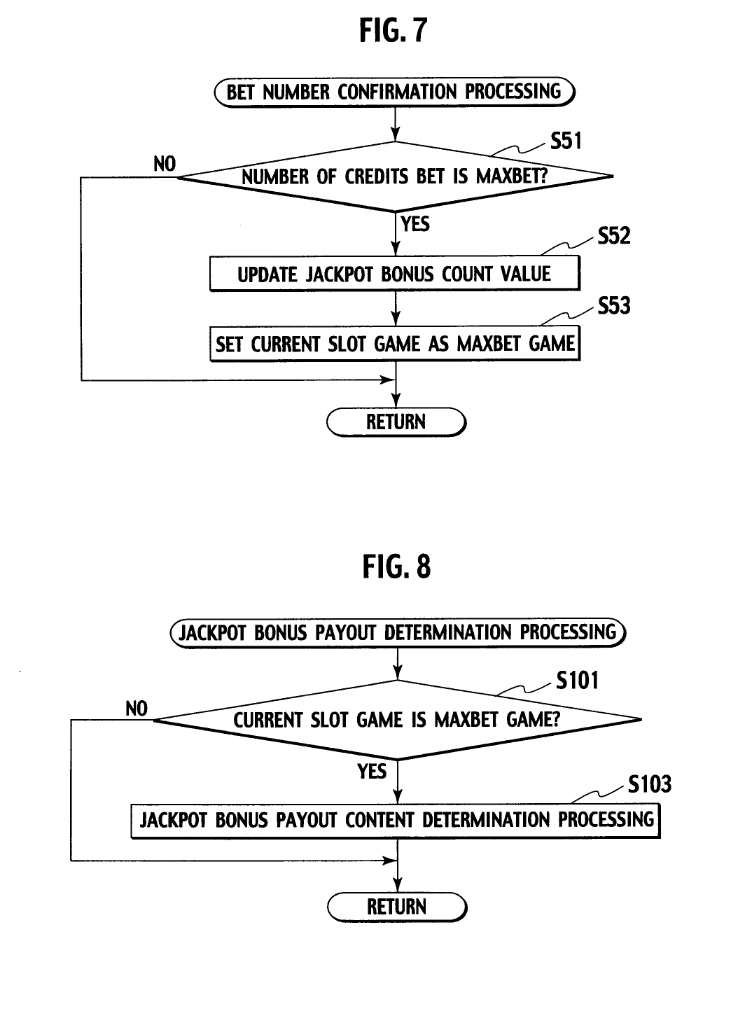

Next, in Step S13, the CPU 106 executes processing of settling the number of the credits bet in Step S11. In this embodiment, this BET number settlement processing is performed by settling whether or not the number of the credits bet in Step S11 is a MAXBET that is an upper limit bet amount. The BET number settlement processing will be described in detail with reference to a flowchart shown in FIG. 7.

Next, in Step S14, the CPU 106 determines whether or not the start switch 27 is pressed. In this step, the CPU 106 determines whether or not a signal outputted from the start switch 27 when the start switch 27 is pressed is received.

When it is determined that the start switch 27 is not pressed, the CPU 106 returns the processing to Step S11. Note that, in the case where the start switch 27 is not pressed (for example, the case where an instruction to finish the game is inputted without pressing the start switch 27), the CPU 106 cancels a result of reduction in the number of credits in Step S12.

Meanwhile, in Step S14, when it is determined that the start switch 27 is pressed, the CPU 106 moves to Step S15 from Step S14 and determines stop-symbols. In this stop-symbol determination processing, the CPU 106 determines the symbols to be stopped and displayed (rearranged) in the respective partitioned regions q11 to q53 by executing a stop-symbol determination program that is one of the game execution programs stored in the ROM 108.

In the stop-symbol determination processing described above, the CPU 106 executes a random number generating program to select a random number value from among values in a range of “0 to 255” for each of the partitioned regions q11 to q53, and determines a stop-symbol for each of the partitioned regions q11 to q53 by referring to correspondence between the random number value and the symbol stored in the ROM 108.

By the stop-symbol determination processing, each of the symbols to be rearranged in each of the partitioned regions q11 to q53 on the first to fifth columns shown in FIG. 2 is determined to be any one of eleven kinds of symbols including seven kinds of planet symbols “VENUS”, “MERCURY”, “SATURN”, “SUN”, “EARTH”, “MARS” and “JUPITER” and four kinds of card symbols “A (ace)”, “K (king)”, “Q (queen)” and “J (jack)”.

Next, the CPU 106 performs processing of symbol varying and displaying in Step S16. In this processing, symbol varying and displaying is started and then stopped in the partitioned regions q11 to q53. By this processing of starting and stopping the varying and displaying, the symbols are rearranged in the partitioned regions q11 to q53.

When the varying and displaying processing is finished, the CPU 106 moves to Step S17 and performs jackpot bonus payout determination processing. In this processing, when the number of the credits bet in Step S11 is the MAXBET, contents of a jackpot bonus (special bonus) payout (including no payout) are determined. The jackpot bonus payout determination processing will be described in detail with reference to a flowchart shown in FIG. 8.

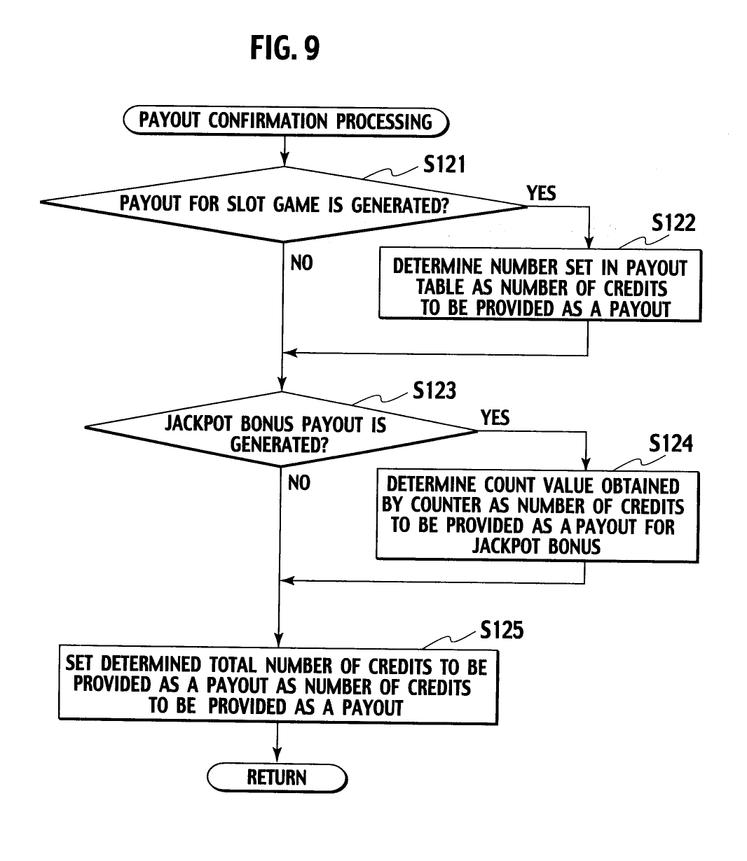

In Step S18, the CPU 106 performs payout settlement processing. In this processing, the CPU 106 determines whether or not the symbols rearranged in the partitioned regions q11 to q53 include the number of symbols of the same kind (KINDs) required to generate a payout for the slot game or whether or not the symbols thus rearranged form a special combination required to generate a jackpot bonus payout. The payout settlement processing will be described in detail with reference to a flowchart shown in FIG. 9.

In Step S19, the CPU 106 executes processing of providing a payout of credits corresponding to a result of the payout content settlement in Step S18 described above. In this payout processing, the CPU 106 adds the number of credits corresponding to the number of payout set in Step S125 shown in FIG. 9 to be described later, to the number of credits stored in the RAM 110. After the payout processing, the CPU 106 returns to Step S11 described above to execute next slot game processing.

FIG. 7 is a flowchart showing detailed procedures of the BET number settlement processing in Step S13 shown in FIG. 6. First, in Step S51, the CPU 106 determines whether or not the number of credits bet in Step S11 is the MAXBET, in other words, the upper limit bet amount. When the number of credits bet is the MAXBET (YES in Step S51), the processing moves to Step S52. On the other hand, when the number of credits bet is not the MAXBET (NO in Step S51), this processing is terminated.

In Step S52, the CPU 106 performs processing of updating a jackpot bonus count value. In this processing, the CPU 106 executes processing of incrementing, by some of the wager (for example, ⅓ of the total number of credits bet), a count value representing the jackpot bonus resources counted by the counter 127 every time the MAXBET is made in Step S11.

Next, in Step S53, the CPU 106 sets the current slot game as a MAXBET slot game. Thereafter, the CPU 106 terminates this processing.

FIG. 8 is a flowchart showing detailed procedures of the jackpot bonus payout determination processing in Step S17 shown in FIG. 6. First, in Step S101, the CPU 106 determines whether or not the current slot game is the MAXBET slot game. Specifically, the CPU 106 determines whether or not the current slot game is the slot game set as the MAXBET slot game in Step S53 shown in FIG. 7. Thereafter, when the current slot game is settled to be the MAXBET slot game, the processing moves to Step S103. On the other hand, when the current slot game is not the MAXBET slot game, this processing is terminated.

In Step S103, the CPU 106 determines jackpot bonus payout contents. To be more specific, the CPU 106 determines whether or not the symbols rearranged in Step S16 described above form a special combination shown in FIG. 1A or FIG. 1B.

When the special combination is formed (YES in Step S103), the CPU 106 sets generation of a jackpot bonus payout in Step S104 and then terminates this processing. On the other hand, when the special combination is not formed (NO in Step S103), the CPU 106 terminates this processing.

FIG. 9 is a flowchart showing detailed procedures of the payout settlement processing in Step S18 shown in FIG. 6. First, in Step S121, the CPU 106 determines whether or not a payout for the slot game is generated. This determination can be made by determining, referring to the payout table shown in FIG. 5, whether or not the symbols rearranged in Step S16 described above include the number of symbols of the same kind set in the payout table stored in the ROM 108.

When a payout for the slot game is generated (YES in Step S121), the CPU 106 determines the number of credits to be provided as a payout in Step S122, as the number set in the payout table, based on the assumption that a payout in the slot game is generated, shown in FIG. 5 so as to correspond to the number of the symbols (KINDs). Thereafter, the CPU 106 moves from Step S122 to the next Step S123. On the other hand, when no payout for the slot game is generated (NO in Step S121), the CPU 106 moves to Step S123.

Next, in Step S123, the CPU 106 determines whether or not generation of the jackpot bonus payout is set in Step S104 shown in FIG. 8. When generation of the jackpot bonus payout is not set (NO in Step S123), the CPU 106 terminates this processing. On the other hand, when generation of the jackpot bonus payout is set (YES in Step S123), the CPU 106 determines the number of credits to be provided as a payout for the jackpot bonus, as the number of credits corresponding to the jackpot bonus resources counted by the counter 127 based on the assumption that a jackpot bonus payout is generated. Thereafter, the CPU 106 moves from Step S124 to the next Step S125.

In Step S125, when the number of credits to be provided as a payout is determined in Step S122 or Step S124, the total number of credits is set as the number of credits to be provided as a payout to the player. Thereafter, this processing is terminated.

In the slot machine 10 according to this embodiment having the configuration described above, when a predetermined number of symbols of the same kind are included in the symbols rearranged in the partitioned regions q11 to q53 on the display 16 by execution of the slot game, a payout corresponding to the number of the symbols is generated as a payout for the slot game.

Moreover, in the slot machine 10 according to this embodiment, when the rearranged symbols form a special combination (see FIG. 1A or FIG. 1B), a jackpot bonus payout is generated.

Specifically, in the slot machine 10 according to this embodiment, whether or not to generate the jackpot bonus payout is determined by a rearrangement pattern of the planet symbols involved in determination of a payout for an all-scatter type slot game.

Therefore, the jackpot bonus payout can be generated based on the result of the symbol rearrangement in the slot game without newly adding symbols other than the symbols involved in determination of the payout for the slot game. Thus, it is possible to eliminate the need for the player to memorize beforehand the kinds (contents) of the symbols to generate a jackpot bonus, in other words, the symbols to serve as a jackpot bonus trigger. Alternatively, in order to eliminate the need described above, it is possible to avoid overlapping with the symbols when displaying characters, marks and the like, which indicate the symbols to serve as the jackpot bonus trigger in an easy-to-understand manner for the player.

Thus, entertainment properties of the slot machine 10 and the playing method thereof can be improved without impairing decorative freedom of the symbols.

Note that, in the embodiment described above, the description was given by taking, as an example, the scatter symbol-type slot machine 10 in which the seven kinds of planet symbols and the four kinds of card symbols are all scatter symbols. However, the present invention is also applicable to a slot machine which generates a payout in a slot game when a winning combination is formed on a payline set in the partitioned regions q11 to q53.

Next, a slot machine according to a second embodiment of the present invention having such a configuration will be described. In the slot machine 10 according to the second embodiment of the present invention, a payline is set in partitioned regions q12, q22, q32, q42 and q52 on the second row across the first to fifth columns. When a winning combination is formed on this payline, a payout is generated in a slot game.

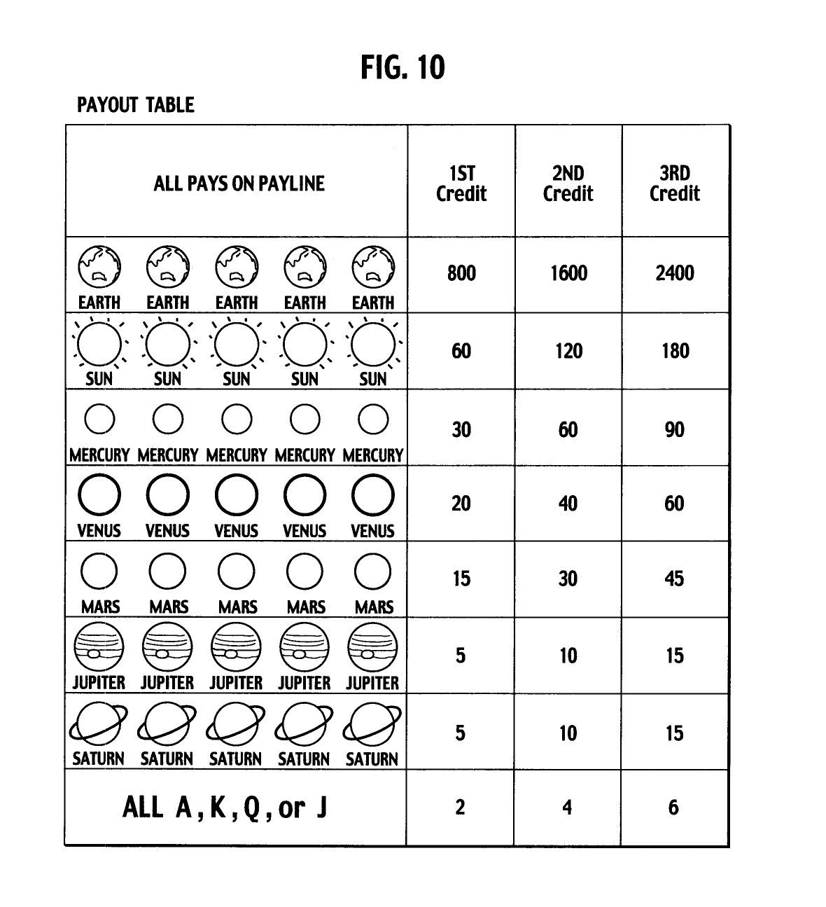

FIG. 10 is an explanatory view showing a payout table associated with a slot game, the payout table being stored in a ROM 108 in the slot machine 10 according to the second embodiment. In this embodiment, when five symbols of the same kind are rearranged on the payline, a winning combination is formed. Moreover, the payout table is set according to the kinds of the symbols that form the winning combination thus formed.

Furthermore, in the slot machine 10 according to the second embodiment, the payout table shown in FIG. 10 is referred to in Step S121 or Step S122 of the payout settlement processing in FIG. 9.

The slot machine 10 according to the second embodiment having the configuration as described above can also achieve the same effects as those achieved by the slot machine 10 according to the first embodiment.

Moreover, in the slot machine 10 according to the second embodiment described above, the payline is set in the partitioned regions q12, q22, q32, q42 and q52 on the second row across the first to fifth columns. However, the present invention is also applicable to a slot machine which has a plurality of paylines set in the partitioned regions q11 to q53 and allows a player to select a payline to be activated by betting credits.

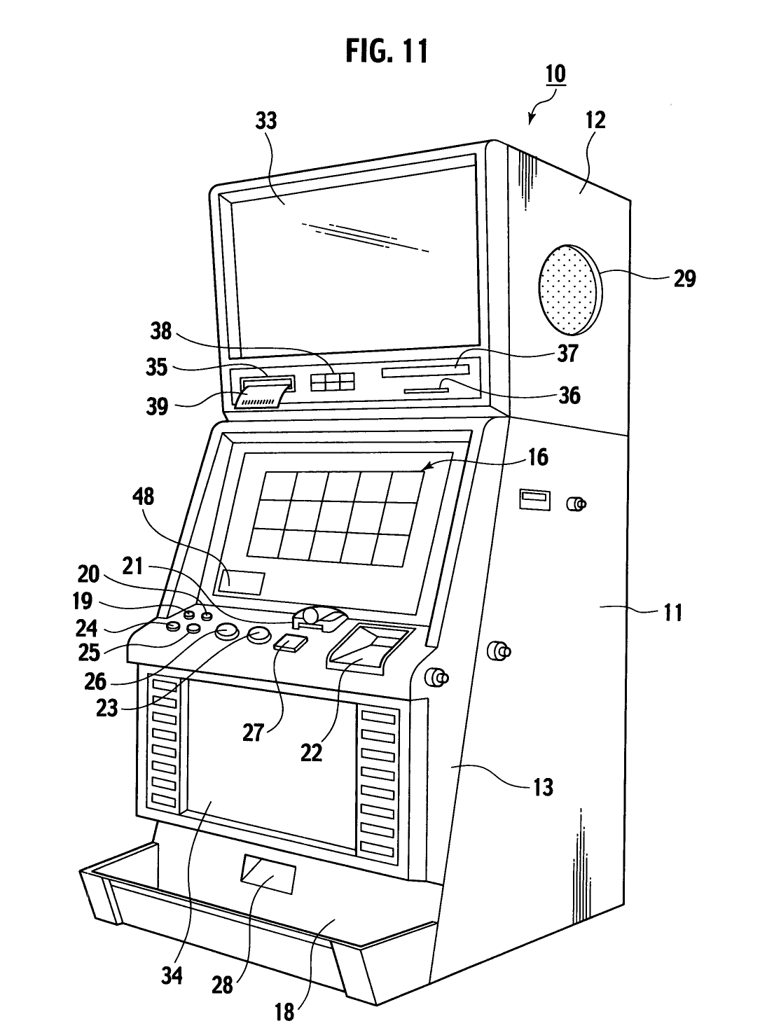

Next, a slot machine according to a third embodiment of the present invention having such a configuration will be described. In the slot machine 10 according to the third embodiment of the present invention, a selection switch 19 and a settlement switch 20 are added as operation switches provided below a display 16, as shown in FIG. 11.

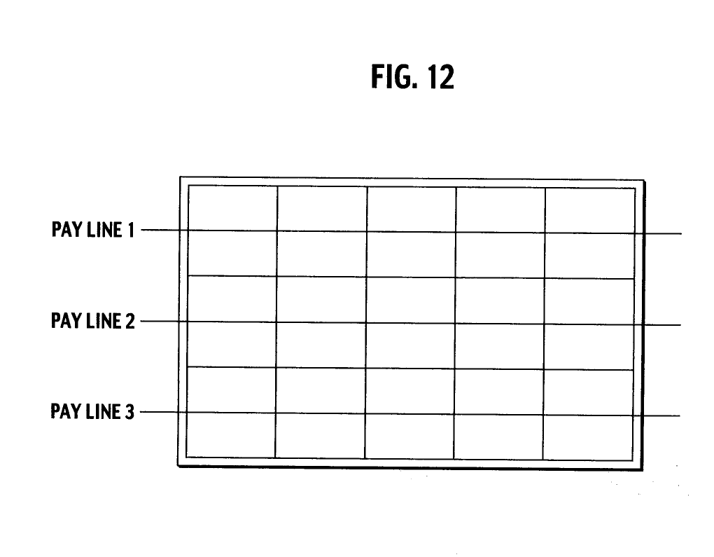

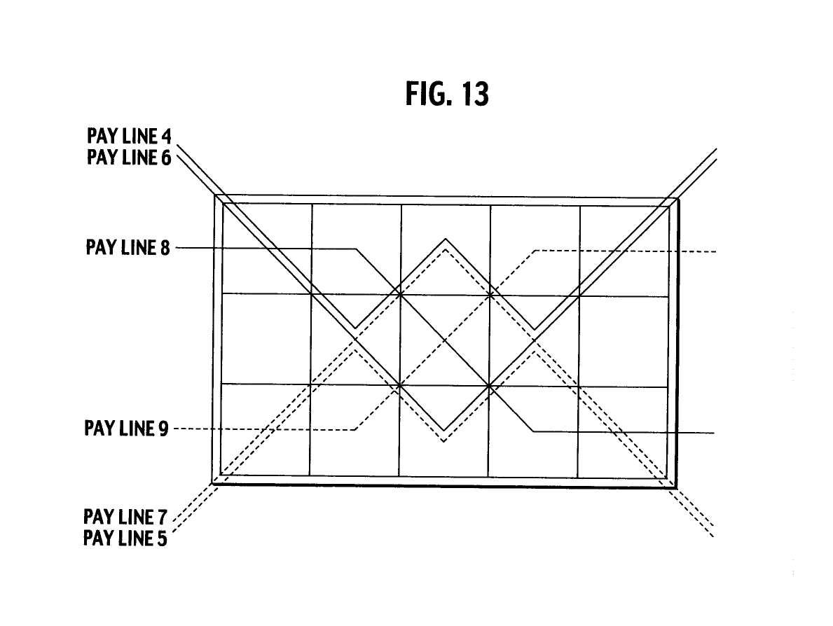

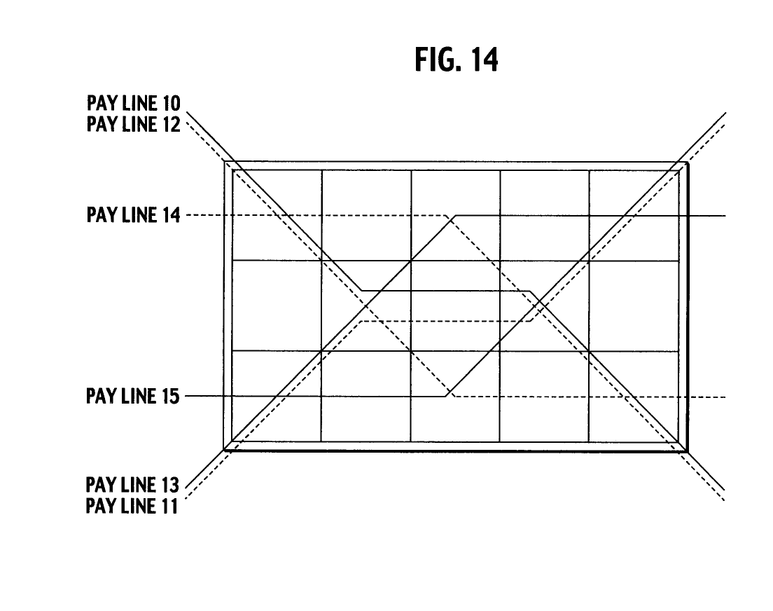

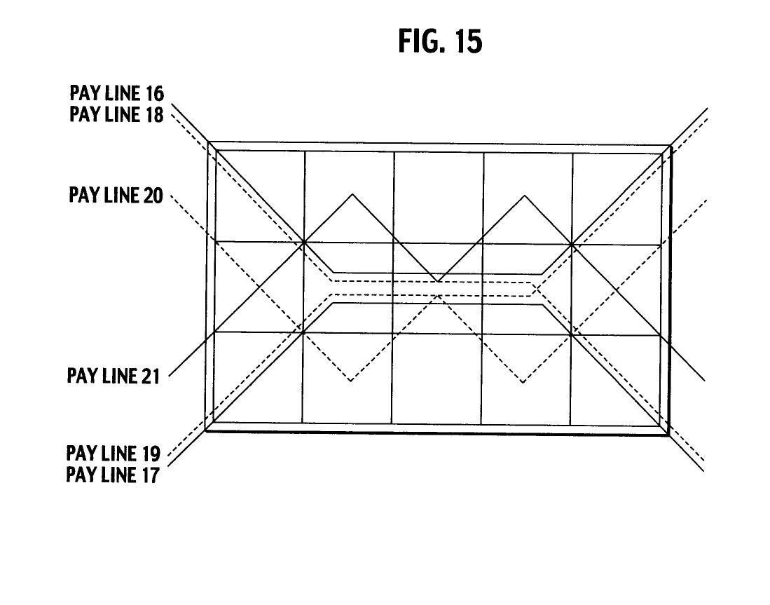

Moreover, in partitioned regions q11 to q53 in the slot machine 10 according to this embodiment, twenty-one paylines are formed in total as shown in FIGS. 12 to 15. A player can select a payline to make a bet on from among those twenty-one paylines by pressing the selection switch 19 described above and can also settle the selection of the payline by pressing the settlement switch 20. By placing a wager on the payline designated (specified) by operating the switches for selection and settlement as described above, the payline is activated in the slot game.

Thereafter, when symbols rearranged in the partitioned regions q11 to q53 form a winning combination on the activated payline, the player can receive a payout corresponding to contents of the winning combination.

Note that, in the slot machine 10 according to this embodiment, the MAXBET switch 24, the BET switch 25 or the spin repeat bet switch 26 is operated to place the same amount of wagers (credits) on each payline to make a bet on, which is designated by pressing the selection switch 19 and the settlement switch 20.

Moreover, in the slot machine 10 according to this embodiment, when the CPU 106 determines, in Step S51 of the BET number confirmation processing shown in FIG. 7, whether or not the number of credits bet in Step S11 is the MAXBET, the amount of wagers (credits) placed on each designated payline to make a bet on is determined whether or not it is the MAXBET.

Furthermore, in the slot machine 10 according to this embodiment, when the amount of wagers (credits) placed on each designated payline to make a bet on is the MAXBET, the CPU 106 executes processing of incrementing a count value, which is obtained by the counter 127, by some of the total amount of wagers placed on the respective paylines to make a bet on, in Step S52 of the BET number confirmation processing shown in FIG. 7.

The slot machine 10 according to the third embodiment having the configuration as described above can also achieve the same effects as those achieved by the slot machine 10 according to the first embodiment.

Note that, in each of the slot machines 10 according to the first to third embodiments described above, rearrangement of the symbols in the partitioned regions q11 to q53 on the display 16 is performed by display on the liquid crystal panel included in the display 16.

However, it is also possible to form the display 16 of a transparent member to rearrange the symbols in the partitioned regions q11 to q53 with the performance by a rotating reel device disposed behind the display.

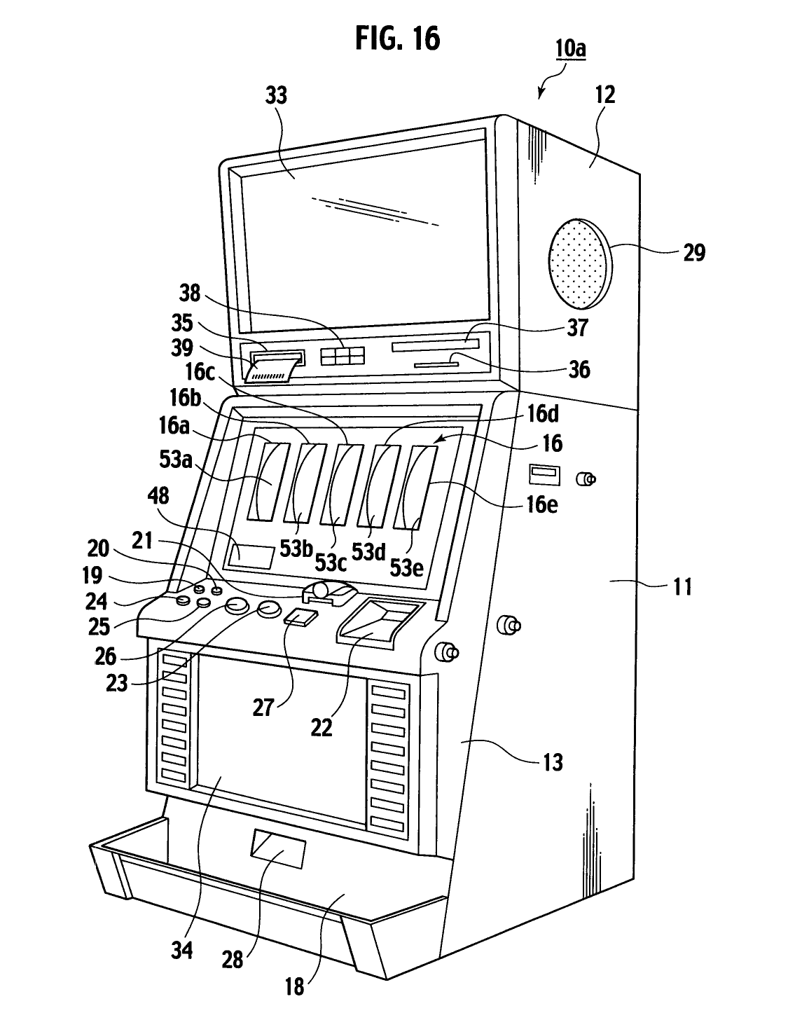

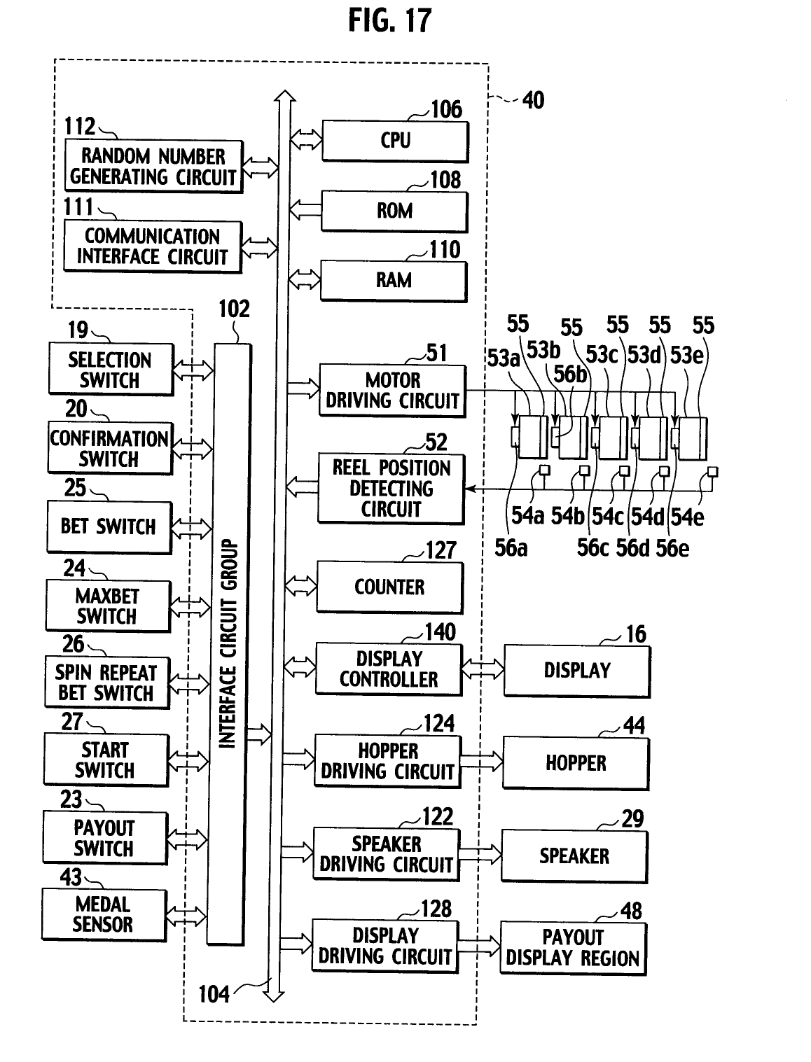

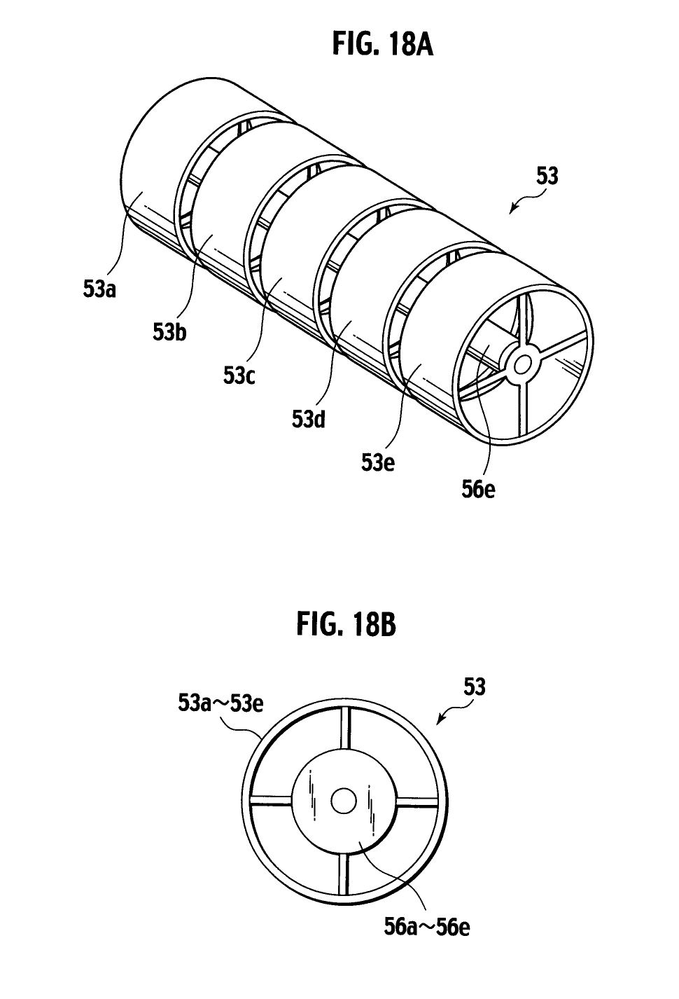

Hereinafter, description will be given of a slot machine according to a fourth embodiment of the present invention, in which symbol rearrangement is performed by the rotating reel device. FIG. 16 is a perspective view of the slot machine according to the fourth embodiment of the present invention. FIG. 17 is a block diagram showing a control circuit in the slot machine according to the fourth embodiment of the present invention. FIG. 18A is a perspective view showing the rotating reel device in the slot machine according to the fourth embodiment of the present invention. FIG. 18B is a side view showing the rotating reel device in the slot machine according to the fourth embodiment of the present invention.

As shown in FIG. 16, in the slot machine 10a according to this embodiment, windows 16a to 16e are provided on the display 16, which are permanently transparently displayed, so as to correspond to the first to fifth columns, respectively. Moreover, inside a cabinet 11, a rotating reel device 53 is disposed so as to be positioned behind the display 16.

As shown in FIG. 18A, the rotating reel device 53 has five rotating reels 53a to 53e corresponding to the windows 16a to 16e on the display 16, respectively. Moreover, as shown in FIG. 18B, the rotating reel device 53 has drive motors 56a to 56e composed of stepping motors for driving to rotate the rotating reels 53a to 53e, respectively. Furthermore, the rotating reel device 53 has sensors 54a to 54e (see FIG. 17) which read bar-codes and count the number of times of passing slits to detect rotation of the respective rotating reels 53a to 53e, stop thereof, and rotation positions where the reels are stopped. Moreover, on a circumferential surface of each of the rotating reels 53a to 53e, a plurality of symbols including the symbols designated in the table shown in FIG. 5 or FIG. 10 are laid out with the equal interval therebetween.

The slot machine 10a according to this embodiment allows the player to view three consecutive symbols among the symbols laid out on the circumferential surface of each of the rotating reels 53a to 53e through each of the windows 16a to 16e on the display 16, the rotating reels corresponding to the windows, respectively. Specifically, each of the windows 16a to 16e on the display 16 includes each of sets of three, top, middle and bottom, partitioned regions in row directions, q11 to q13, q21 to q23, q31 to q33, q41 to q43 and q51 to q53, the sets corresponding to the first to fifth columns, respectively.

Moreover, in the slot machine 10a according to this embodiment, as shown in FIG. 17, the controller 40 includes a motor driving circuit 51 for driving the respective drive motors 56a to 56e in the rotating reel device 53, and a reel position detecting circuit 52 for detecting rotation of the respective rotating reels 53a to 53e, stop thereof, and stop positions thereof with outputs from the respective sensors 54a to 54e in the rotating reel device 53.

Each of the sensors 54a to 54e is disposed so as to face a margin 55 provided in line with a layout area of the symbols on the circumferential surface of each of the rotating reels 53a to 53e corresponding thereto. Moreover, each of the sensors 54a to 54e can detect rotation of each of the rotating reels 53a to 53e, stop thereof, and stop positions thereof by detecting identifiers such as bar-codes laid out on the margin 55 so as to correspond to the respective symbols. Note that, for the detection of the identifiers by each of the sensors 54a to 54e, various known methods can be used, such as an optical method and a magnetic method.

In the slot machine 10a according to this embodiment having the configuration as described above, the processing of symbol varying and displaying in Step S16 of the slot game processing shown in FIG. 6 is executed by rotating and stopping the rotating reels 53a to 53e in the rotating reel device 53 by driving the respective drive motors 56a to 56e through the motor driving circuit 51.

Moreover, in the slot machine 10a according to this embodiment, the processing of determining, in Step S121 of the payout confirmation processing shown in FIG. 9, whether or not the symbols rearranged in the partitioned regions q11 to q53 generates a payout in the slot game is performed based on the result of the detection of rotation of the respective rotating reels 53a to 53e, stop thereof, and stop positions thereof, by the reel position detecting circuit 52, with the use of the outputs from the respective sensors 54a to 54e.

Note that the slot machine 10a according to this embodiment has a plurality of paylines set in the partitioned regions q11 to q53 and allows the player to select, by operating the selection switch 19 and the settlement switch 20 (see FIGS. 16 and 17), a payline to be activated by betting credits.

Therefore, the selection switch 19 and the settlement switch 20 are not required in the scatter symbol-type slot machine such as the slot machine 10 according to the first embodiment or in the slot machine in which a single payline is set in the partitioned regions q12, q22, q32, q42 and q52 on the second row across the first to fifth columns, such as the slot machine 10 according to the second embodiment.

The slot machine 10a according to the fourth embodiment having the configuration as described above can also achieve the same effects as those achieved by the slot machines 10 according to the first to third embodiments.

Although the slot machine and the playing method thereof according to the present invention have been described above based on the illustrated embodiments, the present invention is not limited thereto. The configurations of the respective parts can be replaced with arbitrary configurations having the same functions.

For example, in the above embodiments, the description was given of the case where the display 16 is composed of the fifteen partitioned regions q11 to q53 in the five columns and the three rows. However, the number of the partitioned regions to be arranged in the matrix pattern on the display is arbitrary in both of the column and row directions.

In addition, in the detailed description above, the characteristic portions are mainly described in order to make the present invention easily understandable. The present invention is not limited to the embodiments described in the detailed description above, and can be applied to the other embodiments, and its range of application is wide. Also, the terms and the terminology used in the present specification are used only for the purpose of explaining the present invention precisely, and not used for the purpose of limiting the interpretation of the present invention. Also, for those skilled in the art, it should be easy to contemplate other configurations, systems, methods, etc., that are contained in the concept of the present invention, from the content of the invention described in the present specification. Consequently, the description of the scope of claims should be construed as containing equivalent configurations within a range of not deviating from a range of the technical ideas of the present invention. Also, the purpose of the abstract is to make it possible for the patent office, the general public organizations, and technicians and the like who belong to the present technical field and who are not thoroughly familiar with patent and law terms or specialized terms, to quickly judge the technical content and its essence of the present application by a simple search. Consequently, the abstract is not intended to limit the scope of the invention which should be evaluated by the description of the scope of claims. Also, in order to sufficiently understand the purpose of the present invention and the effects specific to the present invention, they should preferably be interpreted by sufficiently referring to the documents and the like that are already disclosed in public.

Also, the detailed description above contains the processing to be executed by a computer. The explanations and expressions in the above are described for the purpose of facilitating the most efficient understanding by those skilled in the art. In the present specification, each step used in deriving one result should be understood as a processing without a self-contradiction. Also, at each step, transmission and reception, recording, etc., of electric or magnetic signals will be carried out. In the processing at each step, such signals are expressed by bits, values, symbols, letters, terms, numbers, etc., but it should be noted that they are used simply because they are convenient for the purpose of explanation. Also, there are cases where the processing at each step is described by an expression common to the human behavior, but the processing described in the present specification is to be executed by various devices in principle. Also, the other configuration required in carrying out each step will be obvious from the above description.

What is claimed is:

1. A gaming machine comprising:
a display configured to display a unit game to arrange and rearrange a plurality of scatter symbols for awards; and
a controller configured to
(a) select in the unit game the scatter symbols to be rearranged from among a plurality of kinds of scatter symbols including a plurality of kinds of specific scatter symbols and at least one kind of base scatter symbol, and
(b) provide an award for a special bonus upon a plurality of the scatter symbols rearranged in the unit game forming a special combination in which a plurality of the specific scatter symbols of different kinds from each other are arranged in a predetermined pattern.

2. The gaming machine according to claim 1, wherein the controller is configured to provide the award for the special bonus upon the special combination being formed in the unit game on which not less than a predetermined amount of bet is placed.

3. The gaming machine according to claim 1, further comprising:
a counter configured to count a count value of a progressive bonus,
wherein the controller is configured to
increment the count value in the unit game on which not less than a predetermined amount of bet is placed, in accordance with at least some of an amount of the bet placed on the unit game, and
provide a player with at least some of the count value as the award for the special bonus upon the special combination being formed in the unit game on which not less than the predetermined amount of the bet is placed.

4. A gaming machine comprising:
a display configured to display a unit game to rearrange a plurality of arranged symbols; and
a controller configured to
(a) select in the unit game the symbols to be rearranged from among a plurality of kinds of symbols including a plurality of kinds of specific symbols and at least one kind of base symbol, and
(b) provide an award for a special bonus upon a plurality of the symbols rearranged in the unit game forming a special combination in which a plurality of the specific symbols of different kinds from each other are arranged in line, on a payline set on the display.

5. The gaming machine according to claim 4, wherein the controller is configured to provide the award for the special bonus upon the special combination being formed on the payline in the unit game on which not less than a predetermined amount of bet is placed.

6. The gaming machine according to claim 4, further comprising:
a counter configured to count a count value of a progressive bonus,
wherein the controller is configured to
increment the count value in the unit game on which not less than a predetermined amount of bet is placed, in accordance with at least some of an amount of the bet placed on the unit game, and
provide a player with at least some of the count value as the award for the special bonus upon the special combination being formed on the payline in the unit game on which not less than the predetermined amount of the bet is placed.

7. A gaming machine comprising:
a display configured to display a unit game to rearrange a plurality of arranged symbols;
a button configured to specify, for each unit game, a payline for bet among a plurality of paylines set on the display; and
a controller configured to
(a) select in the unit game the symbols to be rearranged from among a plurality of kinds of symbols including a plurality of kinds of specific symbols and at least one kind of base symbol, and
(b) provide an award for a special bonus upon a plurality of the symbols rearranged in the unit game forming a special combination in which a plurality of the specific symbols of different kinds from each other are arranged in line, on the payline specified for bet in response to an operation of the button by the player.

8. The gaming machine according to claim 7, wherein the controller is configured to provide the award for the special bonus upon the special combination being formed on the payline specified for bet in the unit game on which not less than a predetermined amount of bet is placed.

9. The gaming machine according to claim 7, further comprising:
a counter configured to count a count value of a progressive bonus,
wherein the controller is configured to
increment the count value in the unit game on which not less than a predetermined amount of bet is placed, in accordance with at least some of an amount of the bet placed on the unit game, and
provide the player with at least some of the count value as the award for the special bonus upon the special combination being formed on the payline specified for bet in the unit game on which not less than the predetermined amount of the bet is placed.

10. A method for playing a gaming machine configured to display on a display a unit game to arrange and rearrange a plurality of scatter symbols for awards, the method comprising:
selecting in the unit game the scatter symbols to be rearranged from among a plurality of kinds of scatter symbols including a plurality of kinds of specific scatter symbols and at least one kind of base scatter symbol; and
providing an award for a special bonus upon a plurality of the scatter symbols rearranged in the unit game forming a special combination in which a plurality of the specific scatter symbols of different kinds from each other are arranged in a predetermined pattern.

11. The method for playing the gaming machine according to claim 10, wherein the step of providing the award for the special bonus upon the special combination being formed in the unit game includes: providing the award for the special bonus upon the special combination being formed in the unit game on which not less than a predetermined amount of bet is placed.

12. The method for playing the gaming machine according to claim 10, further comprising:
incrementing a count value of a progressive bonus in the unit game on which not less than a predetermined amount of bet is placed, in accordance with at least some of an amount of the bet placed on the unit game, the count value of the progressive bonus being counted by a counter,
wherein the step of providing the award for the special bonus upon the special combination being formed in the unit game includes: providing a player with at least some of the count value as the award for the special bonus upon the special combination being formed in the unit game on which not less than the predetermined amount of the bet is placed.

13. A method for playing a gaming machine configured to display on a display a unit game to rearrange a plurality of arranged symbols, the method comprising:
selecting in the unit game the symbols to be rearranged from among a plurality of kinds of symbols including a plurality of kinds of specific symbols and at least one kind of base symbol, and
providing an award for a special bonus upon a plurality of the symbols rearranged in the unit game forming a special combination in which a plurality of the specific symbols of different kinds from each other are arranged in line, on a payline set on the display.

14. The method for playing the gaming machine according to claim 13, wherein the step of providing the award for the special bonus upon the special combination being formed on the payline in the unit game includes: providing the award for the special bonus upon the special combination being formed on the payline in the unit game on which not less than a predetermined amount of bet is placed.

15. The method for playing the gaming machine according to claim 13, further comprising:
incrementing a count value of a progressive bonus in the unit game on which not less than a predetermined amount of bet is placed, in accordance with at least some of an amount of the bet placed on the unit game, the count value of the progressive bonus being counted by a counter,
wherein the step of providing the award for the special bonus upon the special combination being formed on the payline in the unit game includes: providing a player with at least some of the count value as the award for the special bonus upon the special combination being formed on the payline in the unit game on which not less than the predetermined amount of the bet is placed.

16. A method for playing a gaming machine configured to specify a payline for bet among a plurality of paylines set on a display configured to display a unit game to rearrange a plurality of arranged symbols, for each unit game in response to an operation of a button by a player, the method comprising:
selecting in the unit game the symbols to be rearranged from among a plurality of kinds of symbols including a plurality of kinds of specific symbols and at least one kind of base symbol; and
providing an award for a special bonus upon a plurality of the symbols rearranged in the unit game forming a special combination in which a plurality of the specific symbols of different kinds from each other are arranged in line, on the payline specified for bet in response to the operation of the button by the player.

17. The method for playing the gaming machine, according to claim 16, wherein
the step of providing the award for the special bonus upon the special combination being formed on the payline specified for bet in the unit game includes: providing the award for the special bonus upon the special combination being formed on the payline specified for bet in the unit game on which not less than a predetermined amount of bet is placed.

18. The method for playing the gaming machine according to claim 16, further comprising:
incrementing a count value of a progressive bonus in the unit game on which not less than a predetermined amount of bet is placed, in accordance with at least some of an amount of the bet placed on the unit game, the count value of the progressive bonus being counted by a counter,
wherein the step of providing the award for the special bonus upon the special combination being formed on the payline specified for bet in the unit game includes: providing the player with at least some of the count value as the award for the special bonus upon the special combination being formed on the payline specified for bet in the unit game on which not less than the predetermined amount of the bet is placed.
